(19) United States
(12) Patent Application Publication
(10) Pub. No.: US 2024/0250758 A1
(43) Pub. Date: Jul. 25, 2024

(54) BIO-INSPIRED UNDERGROUND VIBRATIONAL COMMUNICATION

(71) Applicants: Junliang Tao, Chandler, AZ (US); Yi Zhong, Tempe, AZ (US)

(72) Inventors: Junliang Tao, Chandler, AZ (US); Yi Zhong, Tempe, AZ (US)

(21) Appl. No.: 18/419,899

(22) Filed: Jan. 23, 2024

Related U.S. Application Data
(60) Provisional application No. 63/481,001, filed on Jan. 23, 2023.

(51) Int. Cl. H04B 11/00

(52) U.S. Cl. CPC H04B 11/00

(57) ABSTRACT

A system of communication using seismic wave creation and detection, and methods of use of the system are disclosed herein. A system of communication in a medium is applicable for underground applications, allowing the activation of drumming and vibrational sources to send seismic waves through a medium to communicate messages that are converted to binary code. A nearby receiver can detect the seismic waves and decode the data recorded in response to the seismic wave activity before decoding the message. This system of communication enables efficient communication in underground mediums.

### CROSS-REFERENCE TO RELATED APPLICATIONS

This application claims priority to, and the benefit of, U.S. Provisional Patent Application Ser. No. 63/481,001 filed Jan. 23, 2023 entitled “BIO-INSPIRED UNDERGROUND VIBRATIONAL COMMUNICATION.” The foregoing application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### FEDERALLY SPONSORED RESEARCH OR DEVELOPMENT

This invention was made with government support under 1449501 awarded by the National Science Foundation. The government has certain rights in the invention.

### TECHNICAL FIELD

The present disclosure relates to communication systems, and in particular to systems that enable communication with underground devices using seismic waves.

### SUMMARY

A system for transmitting data between devices while at least one of the devices is submerged in a granular medium is disclosed. In various embodiments, the system may comprise a transmitter, a receiver, and a microcontroller.

In various embodiments, the transmitter comprises a transmitter source that may be a vibrational source. In various embodiments, the transmitter source may be a vibration motor. In various embodiments, the transmitter source may be the vibration motor encased in an enclosure. In various embodiments, the vibration motor is coupled to a weight that amplifies the vibration of the vibration motor by coming in contact with the enclosure. In various embodiments, input data may be encoded and decoded using Baudot-Murray code, error-correcting Hamming code and guard intervals.

In various embodiments, the transmitter source may comprise a push-pull solenoid. The push-pull solenoid may engage in a hammering motion while activated. In various embodiments, the transmitter source may be multiple push-pull solenoids. More than one push-pull solenoid in the system may increase the amplitude of the transmitter source and the consistency of the resultant seismic wave.

In various embodiments, the transmitter source may be encased in a three-dimensional box. In various embodiments, the three-dimensional box may be made of 3D printed material. In various embodiments, the push-pull solenoid is encased in the three-dimensional box, and when the transmitter source is activated, the push-pull solenoid moves to strike the three-dimensional box.

In various embodiments the receiver is a micro-electromechanical system (MEMS) accelerometer.

In various embodiments, a microcontroller and a motor driver control the frequency and pattern of the drumming or vibration induced by the transmitter. In various embodiments, an accelerometer measures the vibrations caused by the transmitter source. In various embodiments, the communication system then decodes the measurements to restore the message for the end user.

The foregoing features, elements, steps, or methods may be combined in various combinations without exclusivity, unless expressly indicated herein otherwise. These features, elements, steps, or methods as well as the operation of the disclosed embodiments will become more apparent in light of the following description and accompanying drawings. This section is intended as a simplified introduction to the disclosure and is not intended to limit the scope of any claim.

### BRIEF DESCRIPTION OF THE DRAWINGS

With reference to the following description and accompanying drawings:

FIG. 1 illustrates a transmitter for a communication system wherein the transmitter source comprises a single push-pull solenoid encased in a housing, in accordance with an exemplary embodiment;

FIG. 2 illustrates a transmitter for a communication system wherein the transmitter source comprises two push-pull solenoids encased in a housing, in accordance with an exemplary embodiment:

FIG. 3 illustrates a communication system that accepts input data, converts the input data to binary streams, where it is then encoded by an encoder and modulator and transmitted by a transmitter across a medium to an accelerometer that then decodes the data and generates output data, in accordance with an exemplary embodiment;

FIG. 4 illustrates a transmitter source that transmits data using a vibration motor and a casing, in accordance with an exemplary embodiment;

FIG. 5 illustrates a method of communicating data between devices submerged in a medium using a transmitter and a receiver, in accordance with an exemplary embodiment;

FIG. 6 illustrates a method of communicating data between devices submerged in a medium using a tremulation transmitter source and a receiver, in accordance with an exemplary embodiment; and

FIG. 7 illustrates a method of communicating data between devices submerged in a medium using a hammering push-pull solenoid transmitter source and a receiver, in accordance with an exemplary embodiment.

FIG. 8A illustrates the voltage of a transmitter source with a periodic on-off signal input, in accordance with various exemplary embodiments;

FIG. 8B illustrates the raw and filtered standardized acceleration received by an accelerometer, wherein the accelerometer is embedded at the same depth as the transmitter source, and a horizontal distance of 70 cm from the transmitter source, in accordance with various exemplary embodiments;

FIG. 8C illustrates a scalogram of the unfiltered signals received by an accelerometer, wherein the accelerometer is embedded at the same depth as the transmitter source, and a horizontal distance of 70 cm from the transmitter source, in accordance with various exemplary embodiments;

FIG. 9A illustrates a graph of received seismic signals when the transmitter source sends a text file, in accordance with various exemplary embodiments;

FIG. 9B illustrates a graph of start signal and restored binary code of a text string, in accordance with various embodiments;

FIG. 9C illustrates a graph of stop signal and restored binary code of a text string, in accordance with various exemplary embodiments:

FIG. 10A illustrates the acceleration over time of a sample signal at voltages of 9 V, 10 S V, and 12 V measured by an accelerometer placed 80 cm away from the transmitter source at an embedded depth of 15 cm, in accordance with various embodiments;

FIG. 10B illustrates the acceleration over time of a sample signal at a voltage of 12 V measured by an accelerometer placed 80 cm away from the transmitter source at an embedded depth of 15 cm, in accordance with various embodiments;

FIG. 10C illustrates the acceleration response as a function of distance from a drumming transmitter source at an input voltage of 9 V, 10.5 V, and 12V, in accordance with various embodiments;

FIG. 11A illustrates an experimental setup from a front view, wherein the orange block represents the drumming transmitter source, in accordance with various embodiments;

FIG. 11B illustrates an experimental setup from a top view, wherein the orange block represents the drumming transmitter source, in accordance with various embodiments;

FIG. 12A illustrates the acceleration of the signal of a decoding algorithm, where the raw signal is of a plain text file sent through sand, in accordance with various exemplary embodiments;

FIG. 12B illustrates the acceleration of the signal of a decoding of the starting point of the signal over time, in accordance with various embodiments; and

FIG. 13A and FIG. 13B illustrate decoded image files, wherein FIG. 13A shows an original image that was sent through a soil medium, and FIG. 13B shows restored images received by a receiver, in accordance with various exemplary embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

For the sake of brevity, conventional techniques and components for communication systems may not be described in detail herein. Furthermore, the connecting lines shown in various figures contained herein are intended to represent exemplary functional relationships and/or physical couplings between various elements. It should be noted that many alternative or additional functional relationships or physical connections may be present in exemplary extensible communication systems and/or components thereof.

The internet of underground things (IoUT) is an emerging field involving connected underground components. The two most common components used in the IoUT are sensor nodes and communication modules. Sensor nodes collect data about the underground environment, such as the soil composition, moisture content, temperature, and core water pressure. The IoUT provides remote underground sensing and monitoring. Once this data is collected by the underground sensor nodes, communication modules are used to allow end users to acquire that data in real-time or near real-time through the medium of the ground. The ability to communicate the data efficiently with a large number of sensing nodes is important to the functionality of the IoUT. The systems involved in the IoUT have various applications, including but not limited to geotechnical site investigation, precision agriculture, mine and reservoir monitoring, landslide monitoring, localization, and search and rescue operations.

Communication systems for IoUT could utilize transmission wires, but the number of sensing nodes that would require wiring and expense of maintaining the wires underground makes a wireless communication system more efficient and effective. Currently, a common method of communication in the IoUT in the underground environment uses electromagnetic waves. However, the granular mediums that underground environments usually consist of, for example soil, are lossy materials for electromagnetic waves. The heterogeneous nature of the soil, in which the soil composition varies with space and time, limits the range and reliability of underground wireless communication based on EM waves.

Inspired by the communication method of mole rats, the underground communication devices and techniques disclosed herein include a communication method for the IoUT that uses seismic waves to send data between the devices. Mole rats thump their heads against the ceilings of their tunnels to create a rhythmic, substrate-borne vibrational signal that can be transmitted underground across several meters to reach other mole rats. The communication system in this application is inspired by that method of communication.

Wireless underground sensing networks may provide real-time remote sensing of soil properties and monitoring of underground activities. The wireless underground sensing networks may comprise two or more sub-systems, wherein one or more of the sub-systems is at least partially buried in a granular medium, such as soil. In various embodiments, electromagnetic waves may facilitate wireless communication between the sub-systems. In other embodiments magnetic induction-based communication may be implemented. The magnetic induction-based communication system may be advantageous in facilitating communication in soil where there may be a high loss of signal strength and fidelity. The magnetic permeabilities of air, water, and soils are similar, and therefore the magnetic induction-based communication system is able to facilitate communication effectively in a variety of mediums, including soil. Magnetic induction-based communication also does not require a large antenna, instead operating with a small coil of wire.

In various exemplary embodiments, seismic and acoustic communication may also enable communication between sub-systems wherein at least one of the sub-systems is at least partially buried in a granular medium. In various exemplary embodiments, a mechanism to produce vibrational signals may employ drumming with a drumming mechanism, wherein drumming produces vibrations when something strikes a medium in a percussive event. In various exemplary embodiments, tremulation my be used to produce vibrations at frequencies that have a purer tone that is narrow-banded and low in frequency.

In various exemplary embodiments, the communication system may comprise a transmitter and a receiver. The system transmits data while underground to a receiver by thumping, vibrating or otherwise creating seismic waves. The transmitter may be programmed to encode the data to be communicated using an on-off-keying decoding algorithm. The on-off-keying decoding algorithm may be enhanced with an error-correction algorithm.

The communication system may accept an input message that consists of text, numbers and images. The communication system may be programmed to then encode the input message and convert it into a source signal. Then, the source signal may travel through the medium to a receiver. The receiver may be programmed to then decode the input data to provide the output data to an end user. In some embodiments, the communication system may encode the input message into binary streams and translated to a series of vibrations that can be translated into a series of vibrations by the transmitter. The seismic waves created by the vibrations may travel through the medium and may be picked up by a receiver. The receiver may be a micro-electromechanical system (MEMS) accelerometer.

In various embodiments, a transmitter may comprise a mini vibration motor with an eccentric weight on an output shaft, wherein the output shaft is encased in an acrylic tube. The mini vibration motor may be activated to rotate the eccentric weight, which results in vibrations. The amplitude and frequency of the vibrations vary based on the input voltage of the mini vibration motor. In various embodiments, the mini vibration motor may consume a low amount of energy, requiring 3V input voltage wherein the current is 210 mA and the power is 0.6 Watts.

In various embodiments, a transmitter may comprise a push-pull solenoid encased in a box. The box may be a 3D printed box. The push-pull solenoid may be activated using a microcontroller board to deliver the electric control signal to the motor controller coupled to the push-pull solenoid. When the push-pull solenoid is activated, it may hammer the 3D-printed case.

Further disclosed herein is a communication system to deliver messages while one or more subparts of the communication system is submerged in a medium. The communication system may utilize on-off keying to modulate the signal from the transmitter. The message may be encoded using a variable length code, for example Morse Code, for number and letter messages. The message may be encoded using a 5-bit coding method, for example Baudot-Murray code, for complex messages.

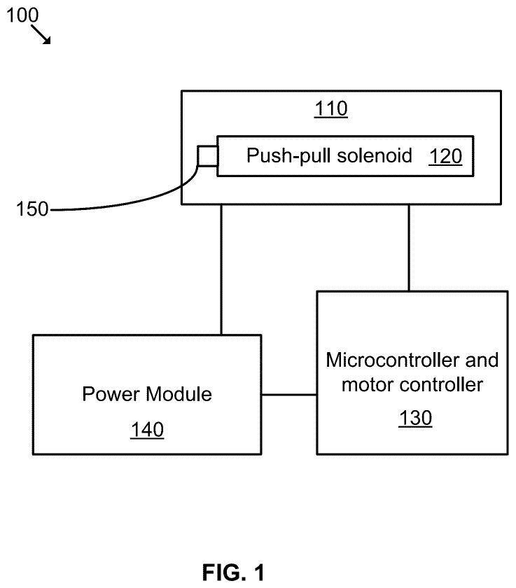

With reference now to FIG. 1, an exemplary communication system transmitter 100 is illustrated. A power module 140 powers a microcontroller 130 that activates a single push-pull solenoid 120 that is enclosed by a casing 110. The single push-pull solenoid is directed by the microcontroller 130 to transmit an encoded message by pushing and pulling a plunger 150 against the casing 110. The contact between the casing and the weight at a specific frequency sends seismic waves through a medium in which the transmitter 100 is submerged.

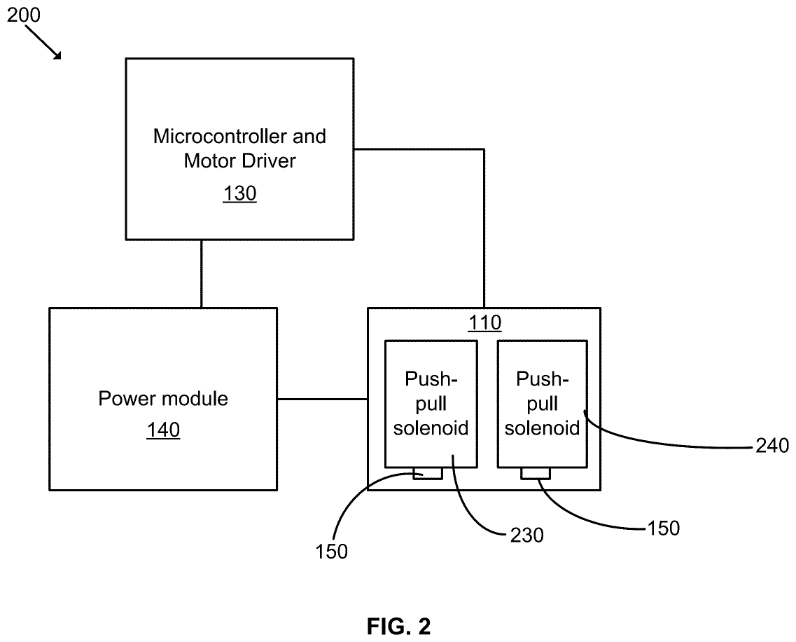

With reference to FIG. 2, an exemplary communication transmitter device 200 is illustrated. A power module 140 powers a microcontroller 130 that activates a first push-pull solenoid 230 and a second push-pull solenoid 240, wherein the first push-pull solenoid 230 and second push-pull solenoid 240 are enclosed by a casing 110. The two push-pull solenoids can be directed by the microcontroller 130 to transmit an encoded message by pushing and pulling a plunger 150 against the casing 110. The casing may be made using a three-dimensional printer or any other suitable technique or material. The two push-pull solenoids allow for a greater magnitude of seismic waves to be detected when they are activated to move in unison, and for a higher frequency when directed to move separately.

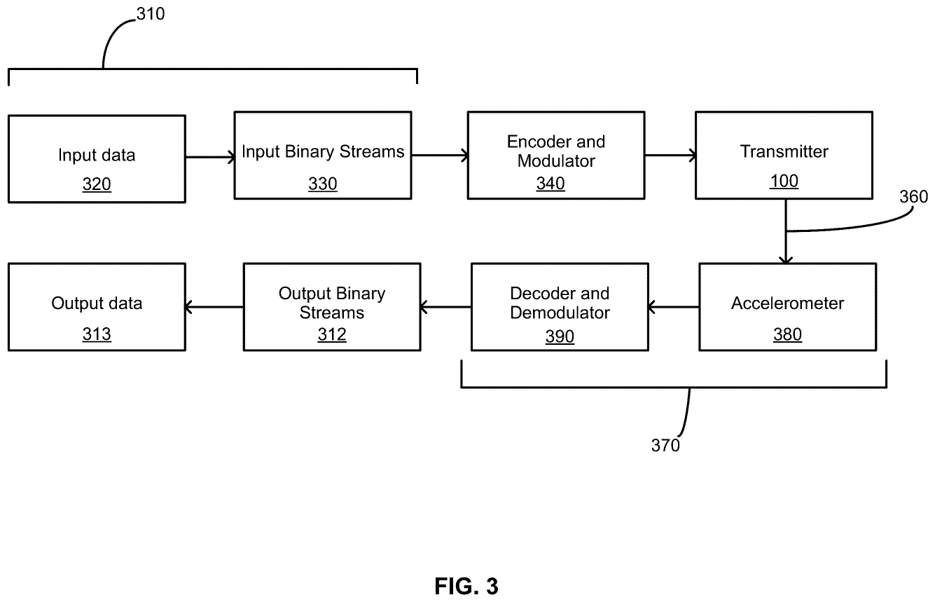

With reference now to FIG. 3, an exemplary communication system is disclosed, wherein the input data 320 is communicated by input binary streams 330 which are then encoded by the encoder and modulator 340 and given to the transmitter to be converted into vibration or drumming. The transmitter 100 may comprise a vibration motor or a push-pull solenoid. The vibration or drumming generated by the transmitter source creates seismic waves 360 which are then detected by the receiver 370, which comprises an accelerometer 380, decoder and demodulator 390. The receiver 370 then outputs the output binary streams 312 to generate the output data 0.

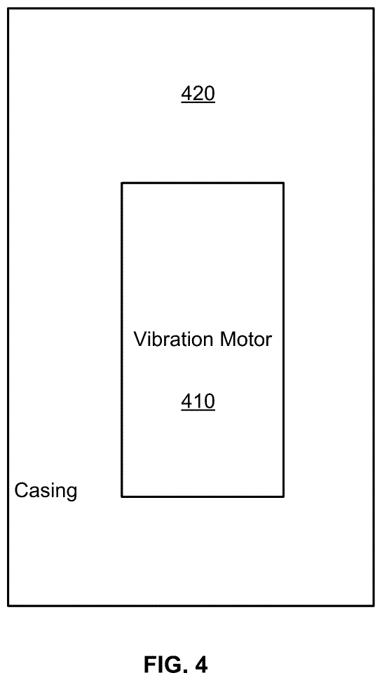

With reference to FIG. 4, an exemplary transmitter source is disclosed, wherein a vibration motor 410 is encased in a casing 420. When the vibration motor 410 is activated, it vibrates and causes the casing 420 to vibrate, sending seismic waves through the medium in which the transmitter source is submerged.

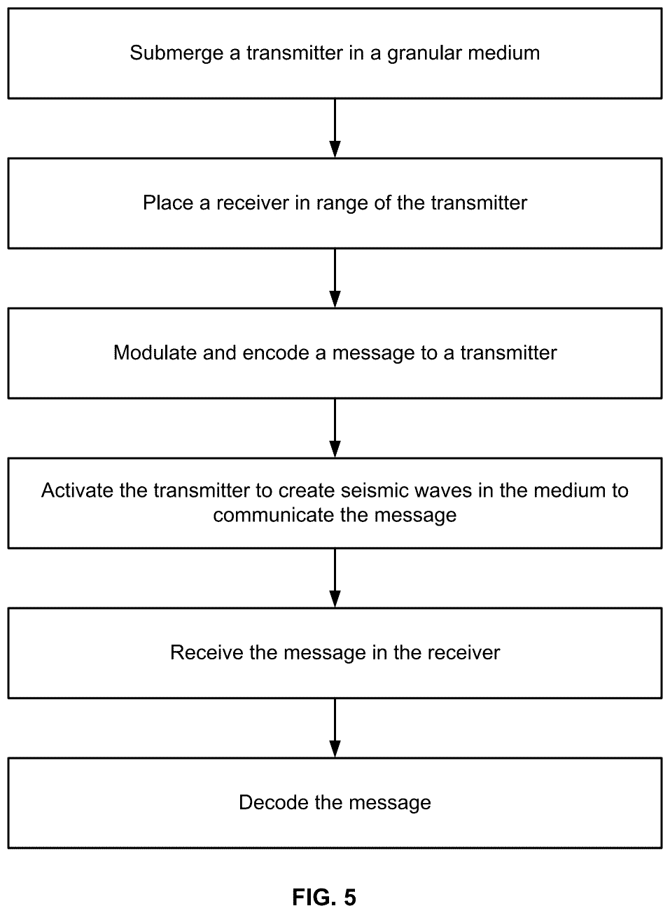

With reference to FIG. 5, an exemplary method for communicating between submerged devices is disclosed. A transmitter may be submerged in a medium. A receiver may be placed in range of the transmitter. A message may be dispatched to the transmitter and encoded, and the transmitter may be activated to create seismic waves that travel through the medium and are intercepted and decoded by a receiver. Once decoded, an end user can interpret the message as it was originally inputted to the transmitter.

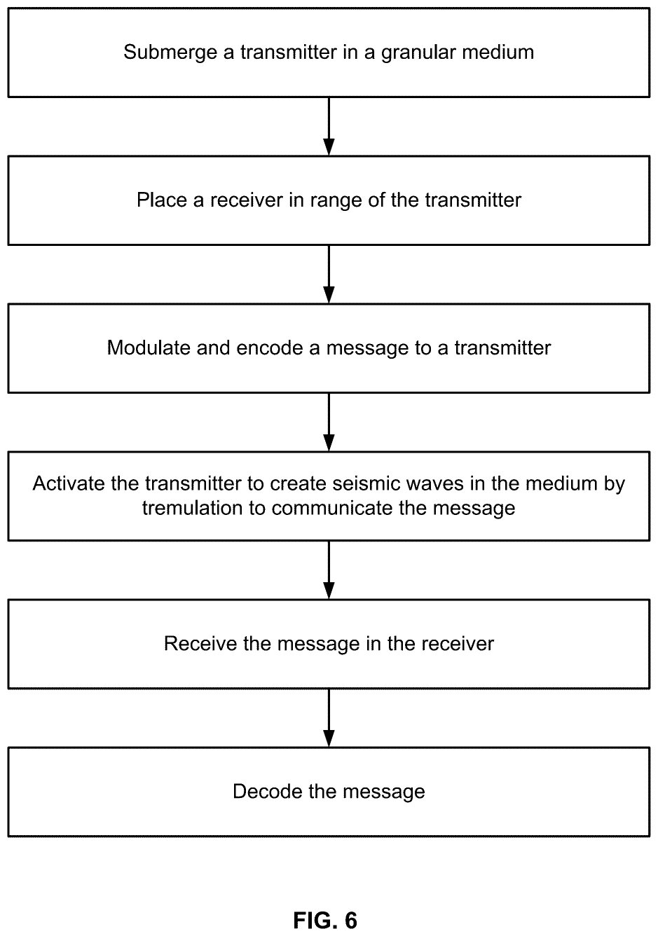

With reference to FIG. 6, an exemplary method for communicating between submerged devices is disclosed. A transmitter may be submerged in a medium. A receiver may be placed in range of the transmitter. A message may be dispatched to the transmitter and encoded. The transmitter source may be a drumming transmitter source or a vibrational transmitter source. The drumming transmitter source may comprise one or more push-pull solenoids. The drumming transmitter source may be activated by thumping at least one plunger 150 against a casing, which thereby creates seismic waves that travel through the medium and are intercepted and decoded by a receiver. Once decoded, an end user can interpret the message as it was originally inputted to the transmitter.

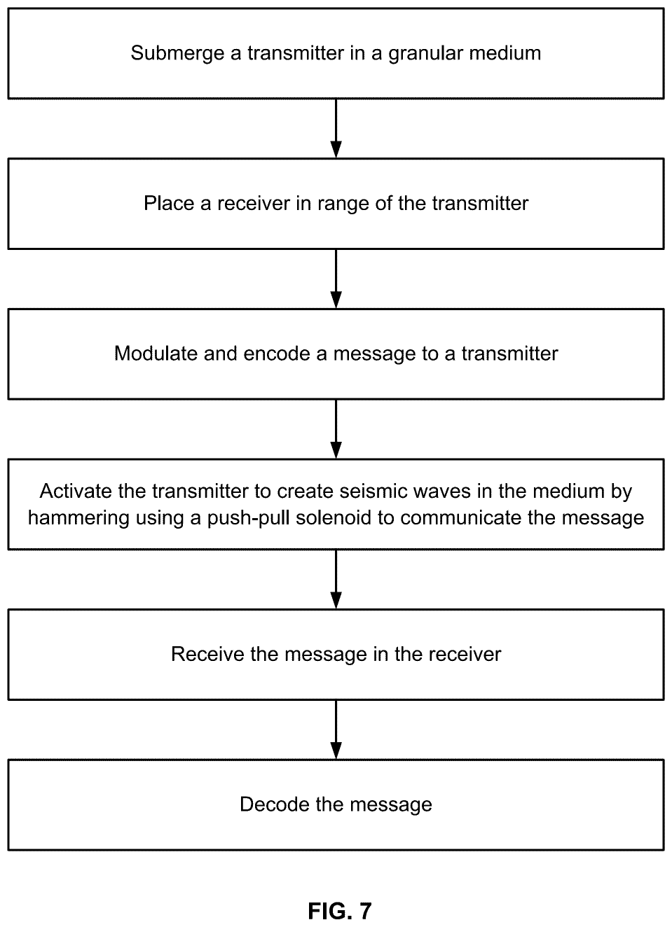

With reference to FIG. 7, an exemplary method for communicating between submerged devices is disclosed. A transmitter may be submerged in a medium. A receiver may be placed in range of the transmitter. A message may be dispatched to the transmitter and encoded, and the transmitter may be activated to create seismic waves by vibrating against the medium that travel through the medium and are intercepted by a receiver. Then, the pattern of seismic wave detection may be decoded, and an end user can interpret the message as it was originally inputted to the transmitter.

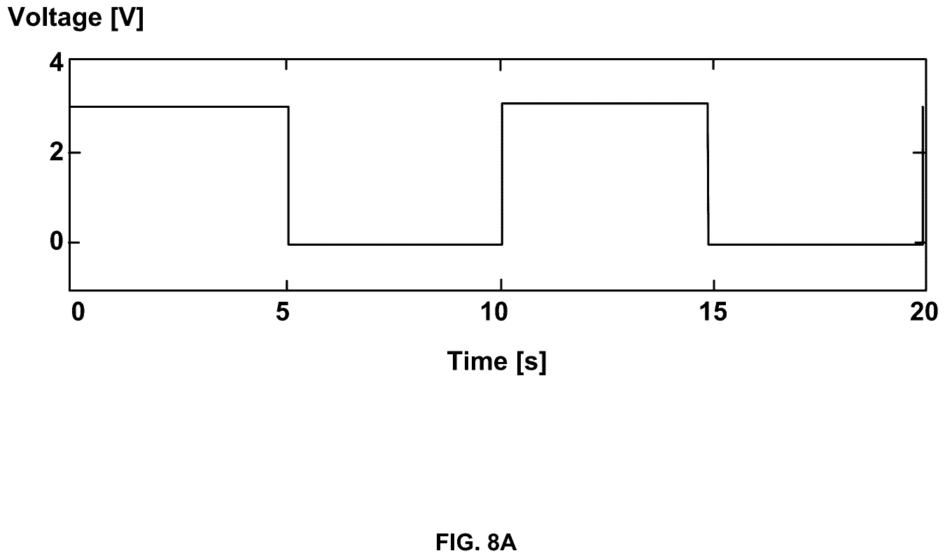

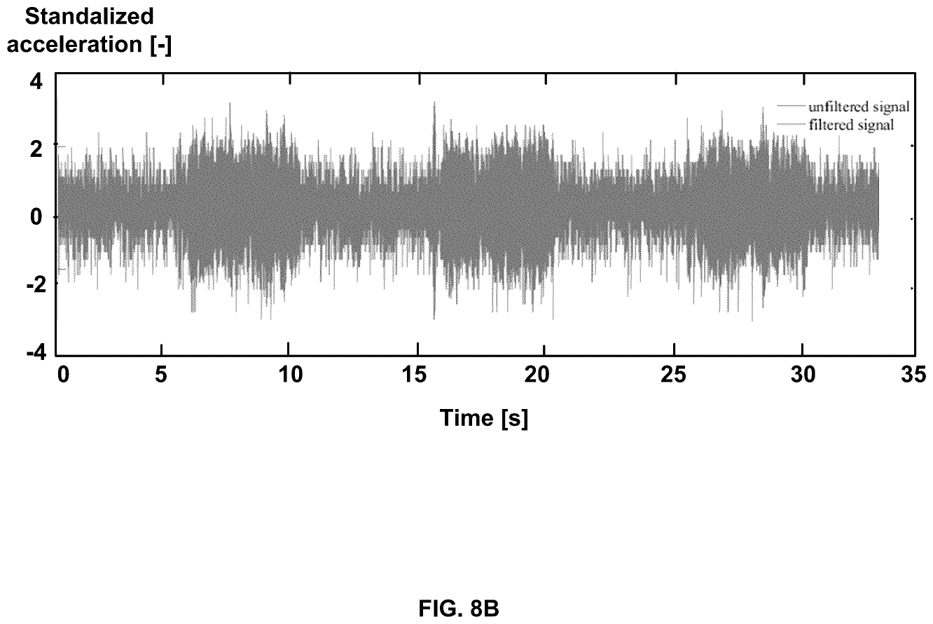

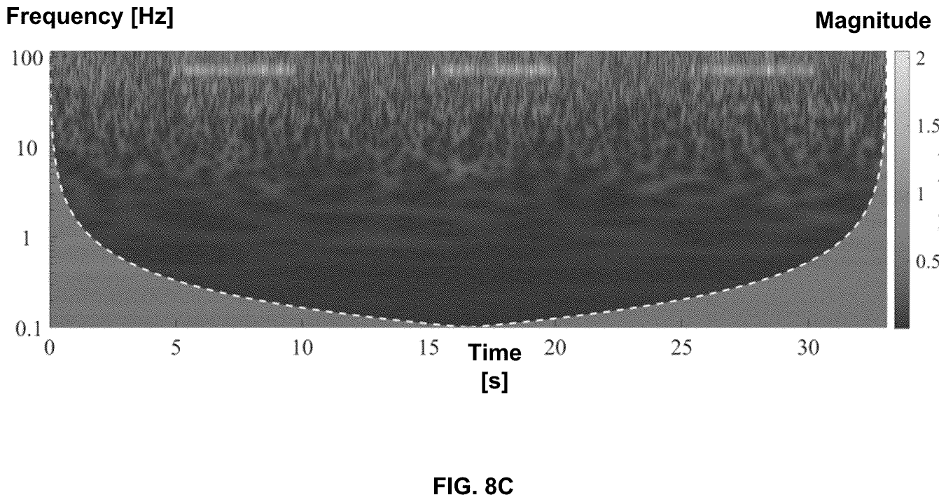

Referring now to FIG. 8, a transmitter source may be evaluated using a wave generator, and an accelerometer. The wave generator and accelerometer may be embedded in a medium, and the wave generator may be supplied an input power voltage according to FIG. 8A. The wave generator supplies a square wave with a high amplitude of 3V and a low amplitude of 0V and a 50% duty cycle. The accelerometer picks up the signals produced by the wave generator, displayed in FIG. 8B as both unfiltered and filtered signals. The unfiltered signal is filtered using a Fourier transformation. FIG. 8C shows a wavelet analysis of the signal to illustrate how signal activities scale over time and frequency. This is illustrated using a scalogram of the unfiltered signal, wherein a pattern consistent with the power input occurred at about 60-80 Hz. A band-pass filter may also be applied to the unfiltered data.

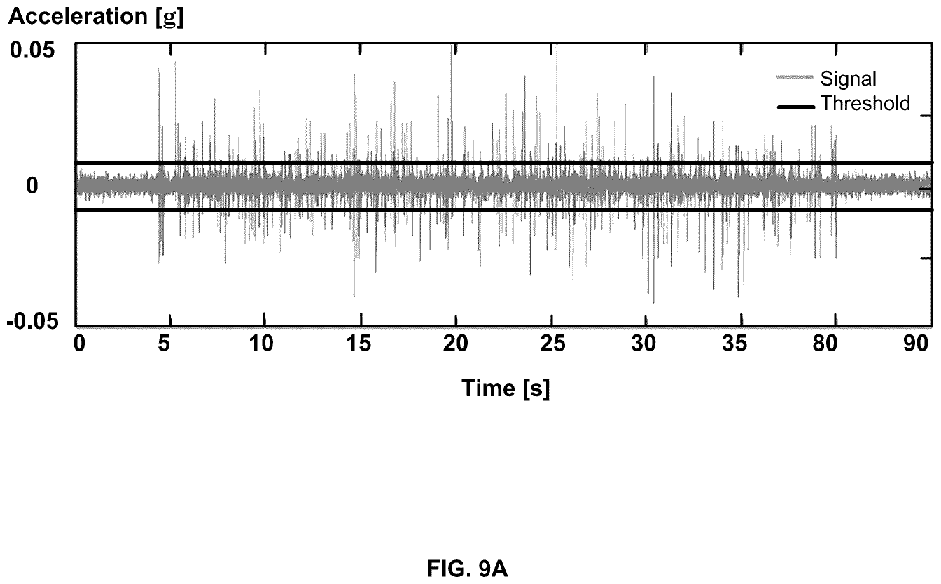

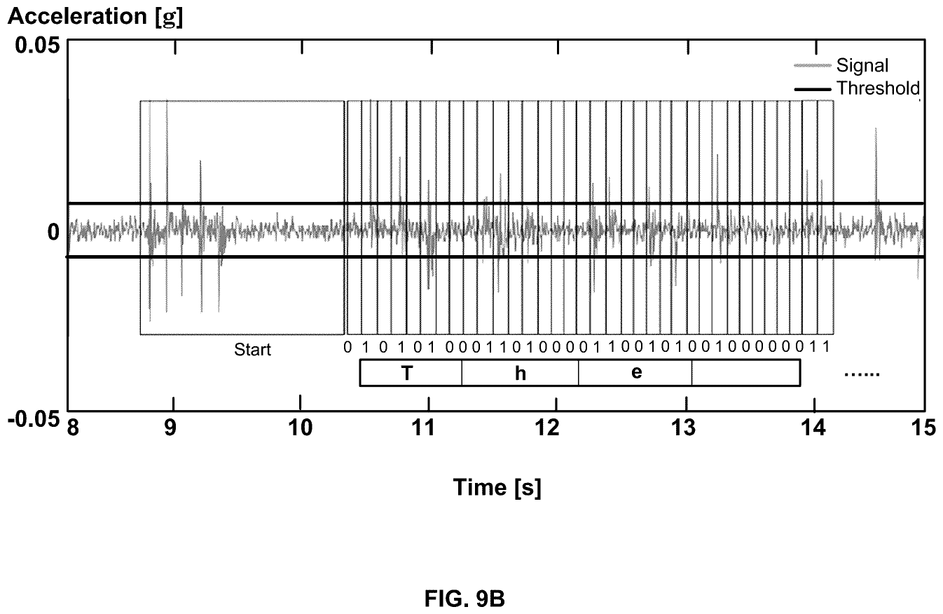

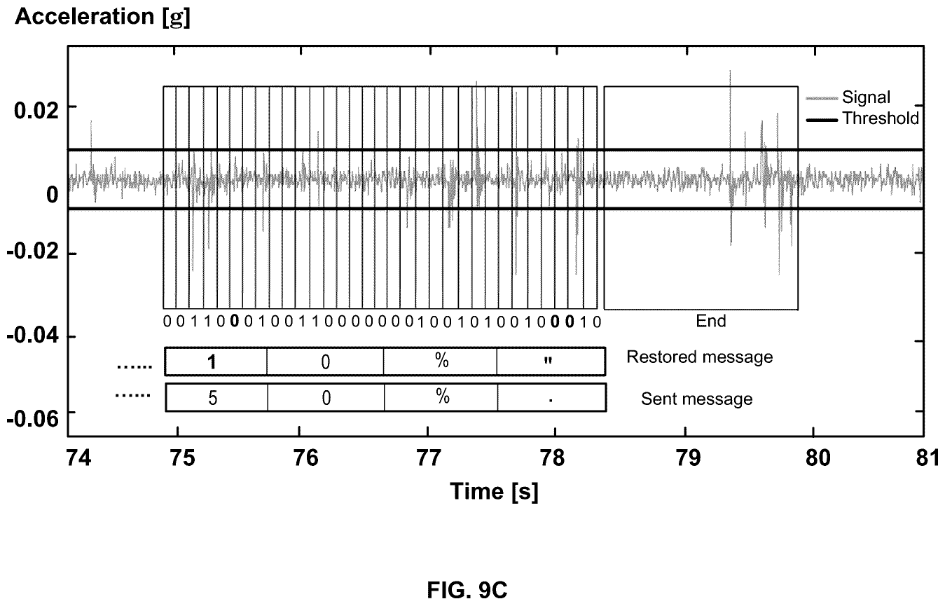

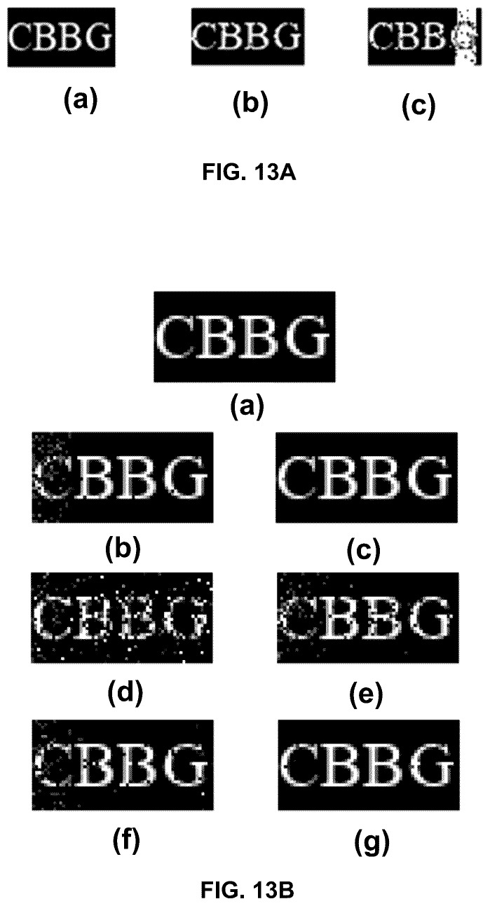

Referring now to FIGS. 9A, 9B, and 9C, a text file and an image may be sent through a granular medium using a drumming transmitter source. In various embodiments, the image may be a 60×30 pixel PNG-coded image. The drumming transmitter source may comprise a housing box, and at least one push-pull solenoid. The average cycle of the push-pull solenoid may be 60 milliseconds, with a maximum absolute deviation of 20 milliseconds. A text code may be converted to binary codes and communicated by the drumming of the push-pull solenoid against the housing box. An accelerometer records the raw acceleration data, which is illustrated in FIG. 9A. The data may then be decoded by dividing the data into subsequences based on the starting and stopping of the push-pull solenoid, the push-pull cycle length, and a guard interval, which is the time between any two consecutive binary digits. Referring to FIG. 9B, wherein the acceleration exceeds a set acceleration threshold which may be set to differentiate binary zeros and ones, an impulse (binary one) may be identified, otherwise a binary zero may be recorded. Referring to FIG. 9C, the acceleration threshold has an impact on the decoding quality, wherein a high acceleration threshold may not detect some impulses. These undetected impulses are illustrated in FIG. 9C where there are deviations in the signal that do not reach the threshold and are therefore not recorded by the accelerometer as binary ones. In various embodiments, an image may be sent and the received image may be compared to the sent image, as in FIG. 13A and FIG. 13B, to determine accuracy of the transmission.

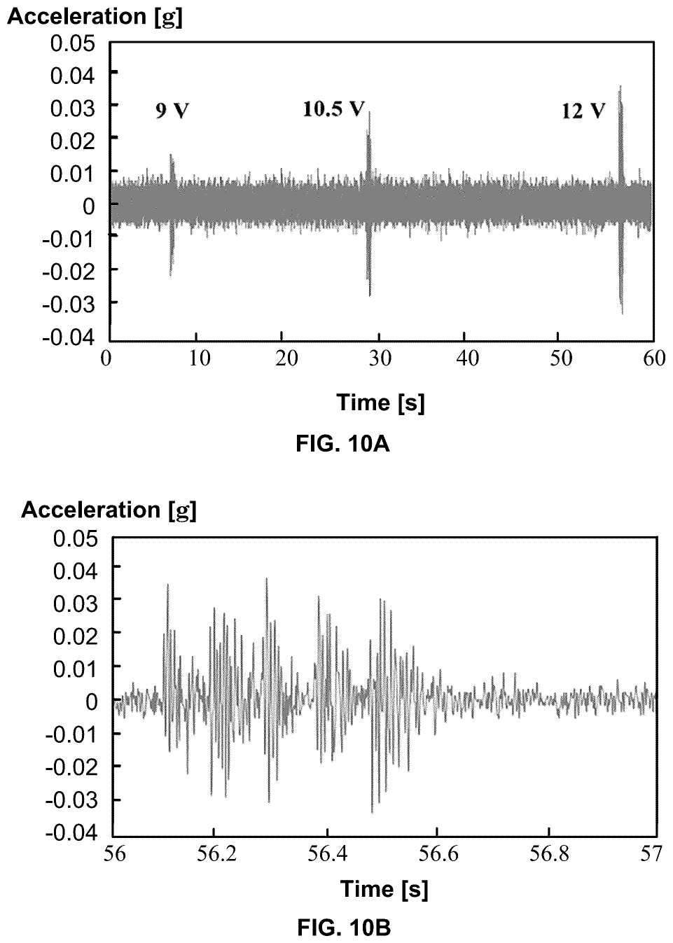

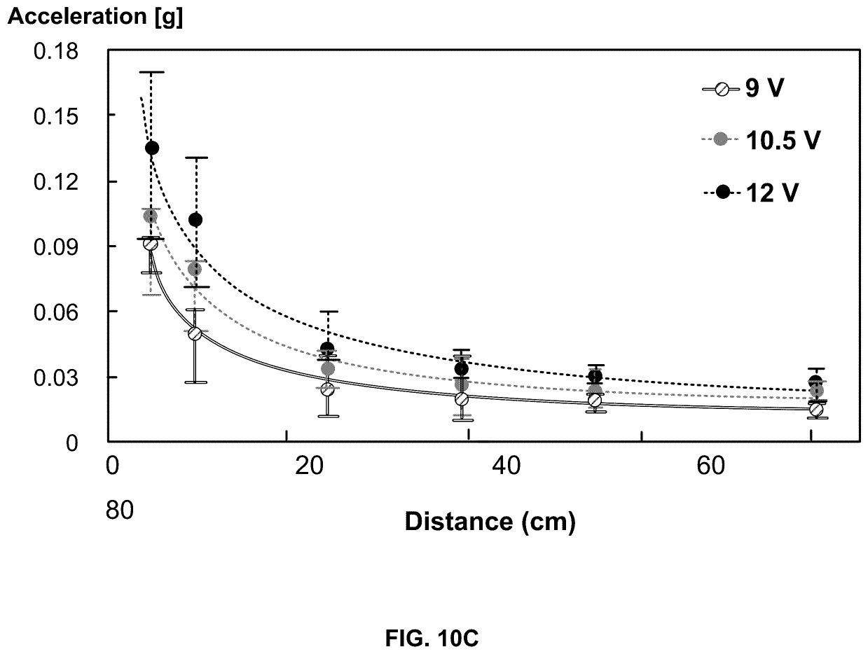

In various embodiments, a transmitter source may be placed at a distance of about 70 cm from the receiver. In various embodiments, the transmitter source may be a drumming source. To maintain the recognizability of the signal pattern as the distance between the transmitter source and the receiver increases, a band filter of 60-80 Hz may be applied to the raw signal based on a wavelet transform analysis. Referring to FIG. 10A, drumming transmitter sources may have clearer raw acceleration when compared to vibration transmitter source signals so a band filter may not be required. The signal may be observed when the input voltage of the transmitter source is varied and while the distance between the transmitter source and the receiver varies. Higher input voltage may result in a higher impacting force for the solenoids, resulting in stronger seismic waves, as shown in FIG. 10A. Referring now to FIG. 10B, the amplitudes of each impulse may be consistent, where the voltage was kept constant at 12 V. Referring to 10C, the relationship between amplitude and distance for the transmitter source at different input voltages of 9 V, 10.5 V and 12 V is graphed, showing the dissipation of waves due to geometric attenuation (a decrease in amplitude due to an increase in size of the wavefront), material loss, and scattering.

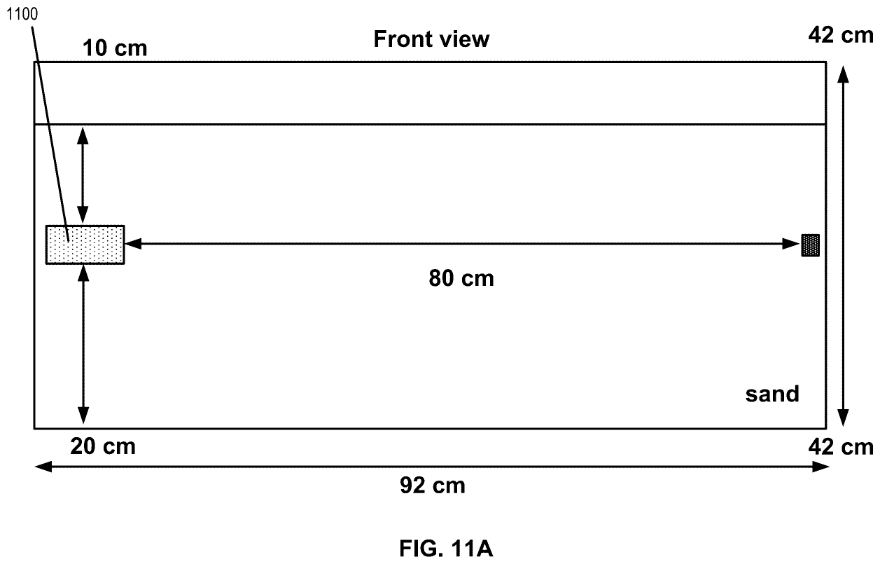

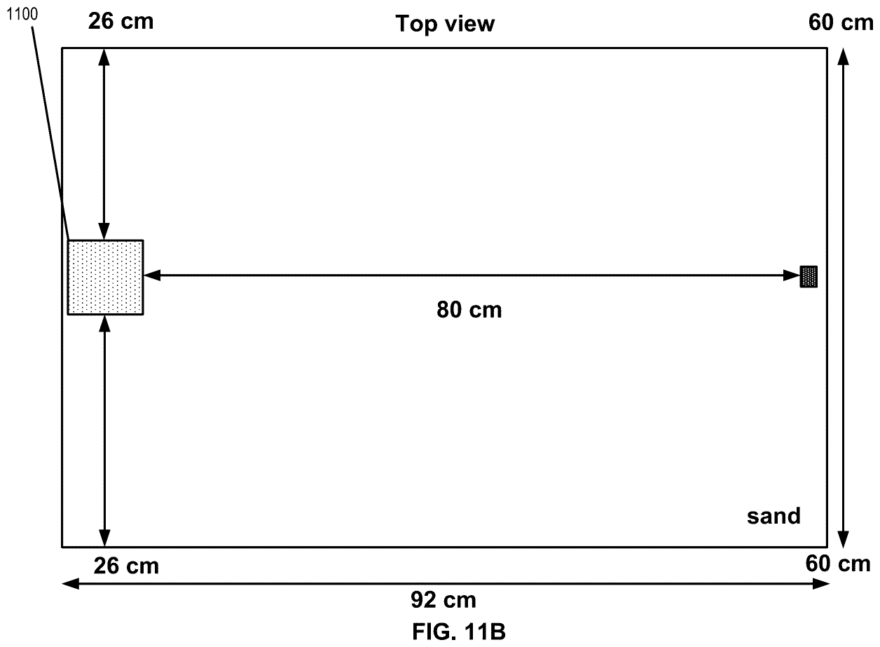

Referring to FIG. 11A and FIG. 11B, an exemplary testing apparatus may be utilized. The testing apparatus may comprise a soil chamber, wherein the soil may be dry Ottawa F65 sand. The testing apparatus may further comprise a microcontroller, a MEMS accelerometer, a vibrational transmitter source, and a decoder. The accelerometer and the vibrational transmitter source may be buried in the soil chamber at the same depth. The vibrational transmitter source may be activated to induce seismic waves in the medium, and the seismic waves may be received by the accelerometer before being decoded by the decoder to restore the intended message. The vibrational transmitter source 1100 may be imbedded in the sand near the side of the soil chamber, as demonstrated in FIGS. 11A and 11B.

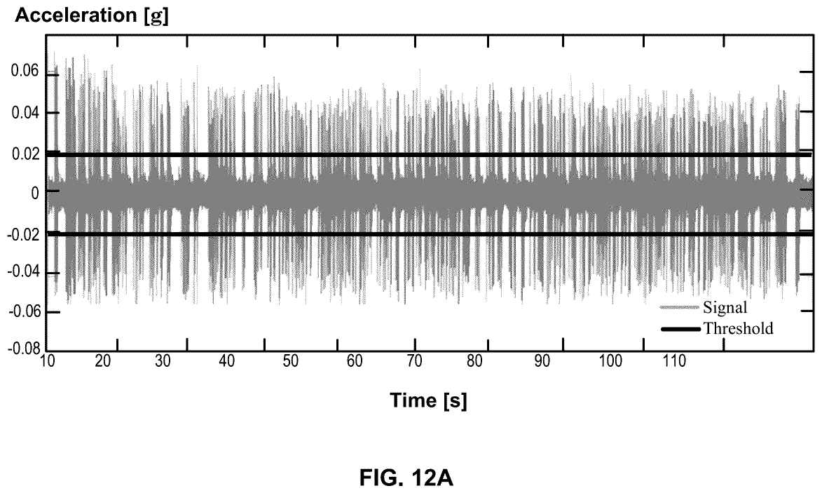

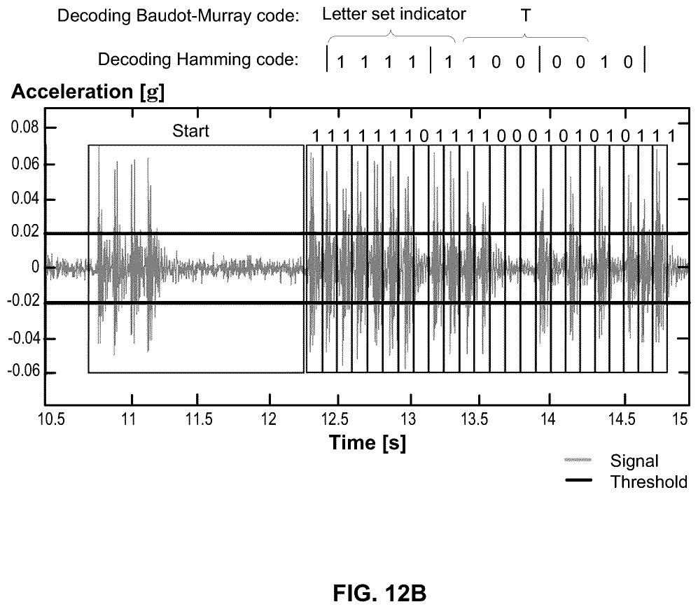

Referring now to FIGS. 12A and 12B, the raw signal of a plain text file sent through sand (FIG. 12A) and the decoding of the starting segment of the signal (FIG. 12B) are graphically illustrated. The exemplary transmitter source and exemplary accelerometer are placed 70 cm apart at a depth of 10 cm. The plain text file is first encoded into a binary stream using the Baudot-Murry code and the Hamming code. A unique binary pattern is inserted before and after the converted binary stream, and the overall binary stream is sent to a microcontroller coupled to the exemplary transmitter source, which activates the transmitter source to communicate the converted binary stream. In various embodiments, the transmitter source communicates the converted binary stream using push-pull solenoids. In various embodiments, a guard interval time may be chosen. In various embodiments, the guard interval time may be four times the standard deviation of one cycle of a push-pull solenoid.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A device for transmitting a message in a granular medium, comprising:
a transmitter source;
a power source;
a solid casing encasing the transmitter source; and
a microcontroller configured to activate the transmitter source at designated frequencies and amplitudes.

2. The device of claim 1, wherein the transmitter source comprises a vibration motor.

3. The device of claim 1, wherein the transmitter source comprises one or more push-pull solenoids enclosed in the solid casing.

4. The device of claim 1, wherein the transmitter source is electronically coupled to the microcontroller.

5. The device of claim 4, wherein the microcontroller is configured to activate the transmitter source according to a provided on-off-keying algorithm to communicate a binary message to an external receiver.

6. The device of claim 5, wherein the device is configured encode the message using Baudot-Murry code before transmitting the message.

7. A system for communication in a medium, comprising:
a transmitter configured to create seismic waves that travel in the medium when submerged, comprising:
a vibration motor;
a microcontroller; and
a weight encased in a solid casing, wherein the vibration motor vibrates the solid casing to rapidly move the weight against the solid casing; and
a receiver configured to receive messages from the transmitter.

8. The system of claim 7, wherein the receiver comprises a micro-electromechanical system accelerometer configured to detect seismic waves.

9. The system of claim 7, wherein the microcontroller activates the vibration motor configured to vibrate while enclosed in a casing at a frequency and amplitude communicated to the transmitter.

10. The system of claim 7, wherein the transmitter activates a transmitter source that is a motor configured to move a push-pull solenoid at a frequency and amplitude communicated to the transmitter.

11. The system of claim 7, wherein the receiver is a micro-electromechanical system accelerometer.

12. A method for communication within a medium using seismic waves, comprising: submerging a transmitter in the medium;
placing a receiver in range of the transmitter;
modulating and encoding a message to the transmitter;
activating a transmitter source using a voltage input to create seismic waves in the medium to communicate the message;
receiving the message in the receiver; and
decoding the message.

13. The method of claim 12, wherein the transmitter creates seismic waves by vibration.

14. The method of claim 12, wherein the transmitter creates seismic waves by hammering using a push-pull solenoid and a solid casing.

15. The method of claim 12, wherein the message is modulated and encoded using Baudot-Murry code and Hamming code to convert the message to a binary stream to create a converted message.

16. The method of claim 15, wherein the transmitter is electronically coupled to a microcontroller.

17. The method of claim 16, wherein the converted message is sent to the microcontroller, wherein the microcontroller is enabled to activate the transmitter.

18. The method of claim 16, wherein the microcontroller switches on the transmitter at time intervals designated by the converted message to create impulses.

19. The method of claim 12, further comprising the receiver continuously recording acceleration values at designated interval and determining data points at which acceleration exceeds a threshold, wherein the threshold is the magnitude of acceleration at which impulses are detected.

20. The method of claim 19, wherein the impulses recorded are translated to a resultant binary code, and the resultant binary code is decoded to reveal the message.
